(19) United States
(12) Patent Application Publication
(10) Pub. No.: US 2026/0128368 A1
(43) Pub. Date: May 7, 2026

(54) SULFIDE SOLID ELECTROLYTE, AND PREPARATION METHOD THEREOF AND USE THEREOF

(71) Applicant: Ningbo Ronbay New Energy Technology Co.,Ltd., Yuyao Ningbo (CN)

(72) Inventors: Xia KONG, Yuyao Ningbo (CN); Huihao LI, Yuyao Ningbo (CN); Daoyan FENG, Yuyao Ningbo (CN); Jonghee LEE, Yuyao Ningbo (CN); Xufeng YAN, Yuyao Ningbo (CN); Xiaoming WANG, Yuyao Ningbo (CN); Jikang LIU, Yuyao Ningbo (CN); Chen ZHAO, Yuyao Ningbo (CN); Hua WANG, Yuyao Ningbo (CN)

(21) Appl. No.: 19/436,714

(22) Filed: Dec. 30, 2025

Related U.S. Application Data
(63) Continuation of application No. PCT/CN2024/102140, filed on Jun. 27, 2024.

(30) Foreign Application Priority Data
Jun. 30, 2023 (CN) 202310798194.3

(51) Int. Cl. H01M 10/0562; H01M 10/0525

(52) U.S. Cl. CPC H01M 10/0562; H01M 10/0525; H01M 2300/008

(57) ABSTRACT

A sulfide solid electrolyte, and a preparation method thereof and a use thereof, where the sulfide solid electrolyte has a chemical composition of LiₐSb_{b}P_{c}S_{d}OₑCl_{f}, where 4.5≤a≤6.5, 0.02≤b≤0.9, 0.01≤e≤0.06, 0.9≤f≤1.6, b+c=1, d+e=5, and a percentage of Sb—S bonding in a total bonding formed by Sb is not less than 98%. In an X-ray diffraction pattern of the sulfide solid electrolyte, intensities of diffraction peaks at 2θ of 29.8±0.25°, 33.33±0.25° and 31.45±0.25° are Iₐ, I_{b} and I_{c}, respectively; where I_{c}/Iₐ is 18-26%, and I_{c}/I_{b} is 25-36%. The sulfide solid electrolyte has good ionic conductivity, and also has good stability in air.

### CROSS-REFERENCE TO RELATED APPLICATIONS

This application is a continuation of International Application No. PCT/CN2024/102140, filed on Jun. 27, 2024, which claims priority to Chinese Patent Application No. 202310798194.3 filed with China National Intellectual Property Administration on Jun. 30, 2023. Both of the aforementioned applications are incorporated by reference in their entireties.

### TECHNICAL FIELD

The present application relates to the field of lithium-ion batteries, and particularly relates to a sulfide solid electrolyte and a preparation method thereof and a use thereof.

### BACKGROUND

Lithium-ion batteries have been widely used in various portable electronic products, new energy vehicles and other fields due to their advantages such as high energy density, high operating voltage, and long service life. However, the liquid electrolytes used in traditional lithium-ion batteries are highly unstable and prone to combustion and explosion under high temperatures, short circuits, or physical impacts, posing significant safety risks. In contrast, solid electrolytes used in solid-state lithium-ion batteries can fundamentally resolve the safety issues of liquid lithium-ion batteries and can also operate under extreme conditions such as high or low temperatures.

Currently, the more extensively studied solid electrolytes mainly include oxide solid electrolytes and sulfide solid electrolytes. Among them, oxide solid electrolytes exhibit high oxidation potential and good stability, but generally suffer from low ionic conductivity, high rigidity, and poor ductility. Sulfide solid electrolytes have higher ionic conductivity and good mechanical properties because the sulfur ions have weaker binding to cations due to smaller electronegativity and facilitate lithium-ion transport due to larger radius. However, sulfide solid electrolytes are unstable in air and readily undergo irreversible side reactions with moisture, oxygen, and carbon dioxide in the air, releasing toxic hydrogen sulfide gas, which causes a collapsed structure of the sulfide solid electrolyte, a decreased ionic conductivity, and affects the long-term cycling performance of the battery, and thus seriously restricts the application of sulfide solid electrolytes in all-solid-state lithium batteries. Therefore, it is necessary to develop a sulfide solid electrolyte with good air stability.

### SUMMARY

In view of the above-described defects in the prior art, the present application provides a sulfide solid electrolyte having good ionic conductivity and having good stability in air.

The present application provides a preparation method of a sulfide solid electrolyte, which method is simple, has low operation cost, and can promote the formation of Sb—S bonding and P—O bonding, improving the air stability and ionic conductivity of the electrolyte.

The present application further provides an all-solid-state lithium-ion battery, including the sulfide solid electrolyte described above. The all-solid-state lithium-ion battery has good cycling performance and rate capability.

The present application provides a sulfide solid electrolyte, having a chemical composition of Formula 1, where a percentage of Sb—S bonding in a total bonding formed by Sb is not less than 98%,

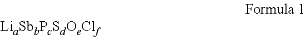

in Formula 1, 4.5≤a≤6.5, 0.02≤b≤0.9, 0.01≤e≤0.06, 0.9≤f≤1.6, b+c=1, d+e=5;
in an X-ray diffraction pattern of the sulfide solid electrolyte, intensities of diffraction peaks at 2θ of 29.8±0.25°, 33.33±0.25° and 31.45±0.25° are Iₐ, I_{b} and I_{c}, respectively, where I_{c}/Iₐ is 18-26%, and I_{c}/I_{b} is 25-36%.

Further, a room-temperature ionic conductivity of the sulfide solid electrolyte is not less than 7.5 mS/cm.

Further, an ionic conductivity retention rate of the sulfide solid electrolyte is not less than 70%.

Further, the sulfide solid electrolyte is prepared by a method including the following process:
mixing Sb₂S₅, a P source and an O source and performing a primary milling, then adding a Li source and a Cl source and performing a secondary milling, to obtain an intermediate phase, sintering the intermediate phase, to obtain the sulfide solid electrolyte.

The present application further provides a preparation method of a sulfide solid electrolyte, including the following steps:
(1) mixing Sb₂S₅, a P source and an O source and performing a primary milling, then adding a Li source and a Cl source and performing a secondary milling, to obtain an intermediate phase; and
(2) performing a sintering treatment on the intermediate phase, to obtain the sulfide solid electrolyte.

Further, in step (1), the P source includes at least one of P₂O₅ and P₂S₅; the O source includes at least one of P₂O₅ and Li₂O; the Li source includes at least one of Li₂O, Li₂S and LiCl; the Cl source includes LiCl.

Further, in step (1), a rotation speed of the primary milling is 350-550 r/min, and a time for the primary milling is 0.5-2 h.

Further, in step (1), a rotation speed of the secondary milling is 350-550 r/min, and a time for the secondary milling is 3-5 h.

Further, in step (2), a temperature of the sintering treatment is 530-580° C., and a time for the sintering treatment is 4-6 h.

The present application further provides an all-solid-state lithium-ion battery, including the foregoing sulfide solid electrolyte.

The sulfide solid electrolyte of the present application includes stable Sb—S bonding and P—O bonding, where a percentage of Sb—S bonding in a total bonding formed by Sb is not less than 98%. Due to the presence of abundant stable Sb—S bonding in the sulfide solid electrolyte, when moisture is present in air, since O in water molecules is less likely to combine with Sb in Sb—S bonding to form Sb—O bonding, S is not easily lost, improving air stability. At the same time, the reason for the sulfide solid electrolyte having good air stability and good ionic conductivity may also be attributed to the fact that in the X-ray diffraction pattern of the sulfide solid electrolyte, the intensities of diffraction peaks at 2θ of 29.8±0.25°, 33.33±0.25° and 31.45±0.25° are Iₐ, I_{b} and L, respectively, where I_{c}/Iₐ is 18-26%, and I_{c}/I_{b} is 25-36%, which enables that the S element in the sulfide solid electrolyte is more stable and is not easily replaced by O in water molecules, thereby improving the stability of the electrolyte in air.

### BRIEF DESCRIPTION OF DRAWINGS

FIG. 1 is a XPS spectrum of a sulfide solid electrolyte according to Example 4 of the present application.

FIG. 2 is Raman spectra of sulfide solid electrolytes according to Example 4 and Comparative Example 6 of the present application.

FIG. 3 is a XRD pattern of sulfide solid electrolytes according to Comparative Example 3 and Example 4 of the present application.

FIG. 4 is a SEM image of a sulfide solid electrolyte according to Example 1 of the present application.

FIG. 5 is a SEM image of a sulfide solid electrolyte according to Example 4 of the present application.

FIG. 6 is a H₂S gas concentration change curves produced by sulfide solid electrolytes according to Example 4 and Comparative Example 1 of the present application after exposure in a glove box at a dew point of −50° C. for 1 h.

### DESCRIPTION OF EMBODIMENTS

To make the objectives, technical solutions, and advantages of the present application clearer, the following clearly and comprehensively describes the technical solutions in embodiments of the present application with reference to the accompanying drawings in embodiments of the present application. Apparently, the described embodiments are merely some rather than all of embodiments of the present application. All other embodiments obtained by persons of ordinary skill in the art based on embodiments of the present application without creative effort shall fall within the protection scope of the present application.

A first aspect of the present application provides a sulfide solid electrolyte, having a chemical composition of Formula 1, where a percentage of Sb—S bonding in a total bonding formed by Sb is not less than 98%,

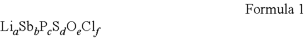

in Formula 1, 4.5≤a≤6.5, 0.02≤b≤0.9, 0.01≤e≤0.06, 0.9≤f≤1.6, b+c=1, d+e=5;
in an X-ray diffraction pattern of the sulfide solid electrolyte, intensities of diffraction peaks at 2θ of 29.8±0.25°, 33.33±0.25° and 31.45±0.25° are Iₐ, I_{b}, and I_{c}, respectively; and I_{c}/Iₐ is 18-26%, and I_{c}/I_{b} is 25-36%.

The present application does not impose specific limitations on a particle size of the sulfide solid electrolyte, and the particle size of the sulfide solid electrolyte may be any diameter.

In the sulfide solid electrolyte of the present application, Sb element and O element are doped, and according to the Hard and Soft Acids and Bases theory, the soft acid Sb is more likely to combine with the soft base S to form a more stable Sb—S bonding, while O tends to combine with P to form P—O bonding, where the percentage of Sb—S bonding in the total bonding formed by Sb is greater than 98%. When there is moisture in the air, since the sulfide solid electrolyte contains a large amount of stable Sb—S bonding, and the S in the Sb—S bonding is not easily replaced by O in the moisture, the generation of Sb—O bonding and by-product H₂S gas, which will result in the collapse of the crystal structure, is effectively avoided, thereby improving the crystal structure stability of the sulfide solid electrolyte in the air environment. At the same time, the reason for high air stability and high ionic conductivity of the sulfide electrolyte may also be attributed to the fact that in the X-ray diffraction pattern of the sulfide solid electrolyte, the intensities of diffraction peaks at 2θ of 29.8±0.25°, 33.33±0.25° and 31.45±0.25° are Iₐ, I_{b} and I_{c}, respectively, where I_{c}/Iₐ is 18-26%, and I_{c}/I_{b} is 25-36%, which enables that the S element in the Sb—S bonding exists stably in the crystal lattice of the sulfide solid electrolyte and is not easily replaced by O in moisture, and the stability of the crystal structure of the sulfide solid electrolyte is effectively improved, thereby improving the air stability and the ionic conductivity of the sulfide solid electrolyte.

In addition, due to large atomic radius and low valence of the doped element Sb, the volume of the unit cell is expanded and the solubility of Li+ in the unit lattice is increased, which reduces the activation energy of Li+ motion. Thus, the ionic conductivity may be further improved.

In a specific implementation, a room-temperature ionic conductivity of the sulfide solid electrolyte is not less than 7.5 mS/cm. Room-temperature ionic conductivity refers to an ionic conductivity at 23-27° C. Specifically, by controlling the milling time, the milling rotation speed, the sintering time, and the sintering temperature, the stability of the S element is further improved, so that the sulfide solid electrolyte has the ionic conductivity described above, and thus the all-solid-state lithium-ion batteries including the sulfide solid electrolyte have good charge-discharge rate capability.

In a specific implementation, an ionic conductivity retention rate of the sulfide solid electrolyte is not less than 70%. The ionic conductivity retention rate of the sulfide solid electrolyte refers to an ionic conductivity retention rate at a temperature of 23 to 27° C. and an air dew point of −48 to −52° C. Specifically, by controlling the doping molar amounts of the Sb source and O source, as well as the milling time, the milling rotation speed, the sintering time, and the sintering temperature, the stability of the S element is further enhanced, so that the sulfide solid electrolyte has the ionic conductivity retention rate described above, and the all-solid-state lithium-ion batteries including the sulfide solid electrolyte have good stability in an air environment, with the ionic conductivity maintained at a good level, thereby reducing the impact on the cycling performance of the batteries.

The present application does not limit the preparation method of the foregoing sulfide solid electrolyte. In a specific implementation, the sulfide solid electrolyte is prepared by a method including the following processes:
mixing Sb₂S₅, a P source and an O source and performing a primary milling, then adding a Li source and a Cl source and performing a secondary milling, to obtain an intermediate phase, sintering the intermediate phase, to obtain the sulfide solid electrolyte.

Specifically, under a protective atmosphere, Sb₂S₅, a P source, and an O source are mixed and subjected to a primary milling, after which an Li source and a Cl source are added for a secondary milling to obtain an intermediate phase; subsequently, the intermediate phase is sintered under a protective atmosphere to yield the sulfide solid electrolyte.

In the present application, the “P source” refers to a raw material for providing the P element, the “O source” refers to a raw material for providing the O element, the “Li source” refers to a raw material for providing the Li element, and the “Cl source” refers to a raw material for providing the Cl element. Any material containing the target elements (P, O, Li, Cl) falls within the scope of the present application, and one target element may be introduced into the reaction system via one or more raw materials. It should be noted that when a raw material contains two or more of the target elements, it can be regarded as an element source for two or more elements. For example, when the raw material is Li₂O, it serves as both the Li source and the O source.

The present application does not impose specific limitations on a molar ratio between Sb₂S₅, the P source, and the O source, or between the Li source and the Cl source, as long as the chemical formula of the prepared sulfide solid electrolyte satisfies Formula 1.

In the above preparation method, selecting Sb₂S₅ as the Sb source, compared to other Sb sources such as Sb₂O₅, not only helps increase the percentage of Sb—S bonding and form a stable crystal structure but also reduces the sintering temperature and ball-milling speed during preparation to reduce energy waste. At the same time, through the primary milling process, the formation of Sb—S bonding and P—O bonding is facilitated, thereby increasing an existence percentage of Sb—S bonding. When moisture is present in the air, since the prepared sulfide solid electrolyte contains a large amount of Sb—S bonding and S in Sb—S bonding is not easily replaced by O in moisture, the sulfide solid electrolyte does not undergo crystal structure collapse due to S loss, is more stable in the air environment, thereby improving its air stability.

A second aspect of the present application provides a preparation method of a sulfide solid electrolyte, including the following steps:
(1) mixing Sb₂S₅, a P source and an O source and performing a primary milling, then adding a Li source and a Cl source and performing a secondary milling, to obtain an intermediate phase; and
(2) performing a sintering treatment on the intermediate phase, to obtain a sulfide solid electrolyte.

Where the P source, O source, Li source, and Cl source are as defined above, and thus will not be reiterated.

Specifically, in step (1), under a sealed and protective atmosphere, Sb₂S₅, the P source and the O source are mixed and subjected to a primary milling, after which the Li source and Cl source are added for a secondary milling to obtain an intermediate phase. In this step, Sb₂S₅, the P source, O source, Li source and Cl source are thoroughly mixed, to facilitate the formation of Sb—S bonding and P—O bonding.

The present application does not impose specific limitations on the protective atmosphere. For example, argon may be selected as the protective atmosphere.

In step (2), the intermediate phase is sintered under a protective atmosphere to yield a sintered product, which is then milled and crushed to obtain the sulfide solid electrolyte. In this step, since the intermediate phase undergoes two milling processes and includes Sb₂S₅ that effectively promotes the formation of Sb—S bonding and P—O bonding, a relatively stable crystal structure can be formed during the sintering treatment, so that the S element in the sintered product is more stable, and when moisture is present in the air, the S element is less likely to be replaced by O from water molecules, preventing side reactions and thereby improving the air stability.

The present application imposes no specific limitations on a molar ratio between Sb₂S₅, the P source, and the O source, or between the Li source and the Cl source, as long as the chemical formula of the prepared sulfide solid electrolyte satisfies Formula 1.

The present application does not limit the specific sources of Sb₂S₅, the P source, O source, Li source, and Cl source. For example, they may be obtained commercially or through conventional preparation methods.

The present application does not impose specific limitations on the milling method. Exemplarily, at least one of mechanical ball milling, high-energy ball milling, or roller milling may be employed.

The present application does not impose specific limitations on the crushing method. Exemplarily, the crushing may be performed using a crusher.

The present application does not impose specific limitations on the protective atmosphere. For example, argon may be selected as the protective atmosphere.

The preparation method of the sulfide solid electrolyte in the present application is simple and easy to implement, with low operational cost. Moreover, through the primary milling process, the formation of Sb—S bonding is promoted, increasing the percentage of Sb—S bonding. As a result, in the prepared sulfide solid electrolyte, the S in Sb—S bonding is less likely to be replaced by O from moisture in an air environment, preventing the generation of by-product H₂S gas and thereby avoiding damage to the crystal structure, so that the prepared sulfide solid electrolyte has excellent air stability and ionic conductivity.

In a specific implementation, the P source includes at least one of P₂O₅ and P₂S₅, the O source includes at least one of P₂O₅ and Li₂O, the Li source includes at least one of Li₂O, Li₂S, and LiCl, and the Cl source includes LiCl.

In a specific implementation, a rotation speed of the primary milling is 350-550 r/min, and a time for the primary milling is 0.5-2 h. When the rotation speed and time of the primary milling fall within the above ranges, the formation of Sb—S bonding and P—O bonding can be effectively promoted, thereby increasing the existence percentage of Sb—S bonding.

In a specific implementation, a rotation speed of the secondary milling is 350-550 r/min, and a time for the secondary milling is 3-5 h. When the rotation speed and time of the secondary milling fall within the above ranges, the raw materials can be mixed more uniformly, facilitating complete reaction of the intermediate phase during the sintering process.

In a specific implementation, a temperature of the sintering treatment is 530-580° C., and a time of the sintering treatment is 4-6 h. When the temperature and time of the sintering treatment fall within the above ranges, a sulfide solid electrolyte with excellent electrical and mechanical properties can be obtained.

A third aspect of the present application provides an all-solid-state lithium-ion battery, including the sulfide solid electrolyte according to the first aspect. The sulfide solid electrolyte included in the all-solid-state lithium-ion battery has good air stability and ionic conductivity, thereby effectively enhancing the performance of the battery.

Hereinafter, the sulfide solid electrolyte of the present application is described in detail through specific examples.

### Example 1

A sulfide solid electrolyte of the present example was obtained by the following preparation method:
(1) Li₂S, Sb₂S₅ and Li₂O were mixed at a specific molar ratio, loaded into a ball mill jar, and sealed. A primary milling was performed, where a rotation speed of the primary milling is 410 r/min, and a time for the primary milling is 1 h. The ball mill jar was transferred into a glove box, then the remaining molar amounts of Li₂S and LiCl were added, and a secondary milling was performed, where a rotation speed of the secondary milling is 410 r/min and a time for the secondary milling is 4 h, to obtain an intermediate phase.
(2) A sintering treatment was performed on the intermediate phase, where a temperature of the sintering treatment is 545° C. and a time for the sintering treatment is 5.5 h, to obtain a sintered product. The sintered product was milled using a crusher to obtain the sulfide solid electrolyte of the present example.

Analysis confirmed that the molecular formula of the solid electrolyte is Li₆Sb_{0.0444}P_{0.9556}S_{1.9722}O_{0.0278}Cl, with a particle size of 20 μm as measured by SEM, as shown in FIG. 4.

### Example 2

A sulfide solid electrolyte of the present example was obtained by the following preparation method:
(1) Li₂O, Sb₂S₅, Li₂S, and a partial molar amount of P₂S₅ were mixed at a specific molar ratio, loaded into a ball mill jar, and sealed. A primary milling was performed, where a rotation speed of the primary milling is 410 r/min, and a time for the primary milling is 1 h. The ball mill jar was transferred into a glove box, then the remaining molar amounts of P₂S₅ and LiCl were added, and a secondary milling was performed, where a rotation speed of the secondary milling is 410 r/min and a time for the secondary milling is 4 h, to obtain an intermediate phase.
(2) A sintering treatment was performed on the intermediate phase, where a temperature of the sintering treatment is 545° C. and a time for the sintering treatment is 5.5 h, to obtain a sintered product. The sintered product was milled using a crusher to obtain the sulfide solid electrolyte of the present example.

Analysis confirmed that the molecular formula of the solid electrolyte is Li₆Sb_{0.0444}P_{0.9556}S_{1.9722}O_{0.0278}Cl.

### Example 3

A sulfide solid electrolyte of the present example was obtained by the following preparation method:
(1) P₂S₅, Sb₂S₅ and Li₂O were mixed at a specific molar ratio, loaded into a ball mill jar, and sealed. A primary milling was performed, where a rotation speed of the primary milling is 430 r/min, and a time for the primary milling is 1.5 h. The ball mill jar was transferred into a glove box, then the remaining molar amounts of Li₂S and LiCl were added, and a secondary milling was performed, where a rotation speed of the secondary milling is 430 r/min and a time for the secondary milling is 4.5 h, to obtain an intermediate phase.
(2) A sintering treatment was performed on the intermediate phase, where a temperature of the sintering treatment is 550° C. and a time for the sintering treatment is 5 h, to obtain a sintered product. The sintered product was milled using a crusher to obtain the sulfide solid electrolyte of the present example.

Analysis confirmed that the molecular formula of the solid electrolyte is Li₆Sb_{0.0667}P_{0.9333}S_{4.9583}O_{0.0417}Cl.

### Example 4

A sulfide solid electrolyte of the present example was obtained by the following preparation method:
(1) Li₂S, Sb₂S₅, Li₂O, and a partial molar amount of P₂S₅ were mixed at a specific molar ratio, loaded into a ball mill jar, and sealed. A primary milling was performed, where a rotation speed of the primary milling is 410 r/min, and a time for the primary milling is 1 h. The ball mill jar was transferred into a glove box, then the remaining molar amounts of P₂S₅ and LiCl were added, and a secondary milling was performed, where a rotation speed of the secondary milling is 410 r/min and a time for the secondary milling is 4 h, to obtain an intermediate phase.
(2) A sintering treatment was performed on the intermediate phase, where a temperature of the sintering treatment is 545° C. a time for the sintering treatment is 5.5 h, to obtain a sintered product. The sintered product was milled using a crusher to obtain the sulfide solid electrolyte of the present example.

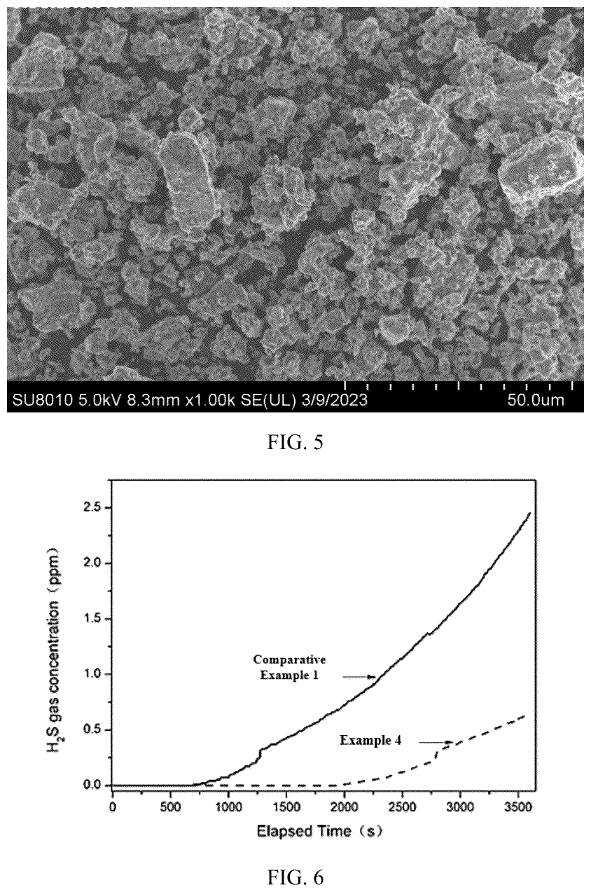

Analysis confirmed that the molecular formula of the solid electrolyte is Li₆Sb_{0.0667}P_{0.9333}S_{4.9583}O_{0.0417}Cl, with a particle size of 15 μm as measured by SEM, as shown in FIG. 5.

### Example 5

(1) Li₂S, Sb₂S₅, P₂O₅, and a partial molar amount of P₂S₅ were mixed at a specific molar ratio, loaded into a ball mill jar, and sealed. A primary milling was performed, where a rotation speed of the primary milling is 375 r/min, and a time for the primary milling is 2 h. The ball mill jar was transferred into a glove box, then the remaining molar amounts of P₂S₅ and LiCl were added, and a secondary milling was performed, where a rotation speed of the secondary milling is 550 r/min and a time for the secondary milling is 3 h, to obtain an intermediate phase.
(2) A sintering treatment was performed on the intermediate phase, where a temperature of the sintering treatment is 530° C. a time for the sintering treatment is 6 h, to obtain a sintered product. The sintered product was milled using a crusher to obtain the sulfide solid electrolyte of the present example.

Analysis confirmed that the molecular formula of the solid electrolyte is Li₆Sb_{0.0333}P_{0.9671}S_{4.9733}O_{0.0278}Cl.

### Example 6

(1) Li₂S, Sb₂S₅, Li₂O, and a partial molar amount of P₂S₅ were mixed at a specific molar ratio, loaded into a ball mill jar, and sealed. A primary milling was performed, where a rotation speed of the primary milling is 380 r/min, and a time for the primary milling is 2 h. The ball mill jar was transferred into a glove box, then the remaining molar amounts of P₂S₅, PCl₃ and LiCl were added, and a secondary milling was performed, where a rotation speed of the secondary milling is 500 r/min and a time for the secondary milling is 3.5 h, to obtain an intermediate phase.
(2) A sintering treatment was performed on the intermediate phase, where a temperature of the sintering treatment is 560° C. and a time for the sintering treatment is 5 h, to obtain a sintered product. The sintered product was milled using a crusher to obtain the sulfide solid electrolyte of the present example.

Analysis confirmed that the molecular formula of the solid electrolyte is Li_{5.5056}Sb_{0.0333}P_{0.9667}S_{4.975}O_{0.0278}Cl.

### Example 7

A sulfide solid electrolyte of the present example was obtained by the following preparation method:
(1) P₂S₅, Sb₂S₅ and Li₂O were mixed at a specific molar ratio, loaded into a ball mill jar, and sealed. A primary milling was performed, where a rotation speed of the primary milling is 550 r/min, and a time for the primary milling is 0.5 h. The ball mill jar was transferred into a glove box, then the remaining molar amounts of Li₂S and LiCl were added, and a secondary milling was performed, where a rotation speed of the secondary milling is 400 r/min and a time for the secondary milling is 5 h, to obtain an intermediate phase.
(2) A sintering treatment was performed on the intermediate phase, where a temperature of the sintering treatment is 580° C. and a time for the sintering treatment is 4 h, to obtain a sintered product. The sintered product was milled using a crusher to obtain the sulfide solid electrolyte of the present example.

Analysis confirmed that the molecular formula of the solid electrolyte is Li₆Sb_{0.0444}P_{0.9556}S_{4.9722}O_{0.0278}Cl.

### Example 8

A sulfide solid electrolyte of the present example was obtained by the following preparation method:
(1) P₂S₅, Sb₂S₅ and Li₂O were mixed at a specific molar ratio, loaded into a ball mill jar, and sealed. A primary milling was performed, where a rotation speed of the primary milling is 430 r/min, and a time for the primary milling is 1 h. The ball mill jar was transferred into a glove box, then the remaining molar amounts of Li₂S and LiCl were added, and a secondary milling was performed, where a rotation speed of the secondary milling is 410 r/min and a time for the secondary milling is 5 h, to obtain an intermediate phase.
(2) A sintering treatment was performed on the intermediate phase, where a temperature of the sintering treatment is 520° C. and a time for the sintering treatment is 5 h, to obtain a sintered product. The sintered product was milled using a crusher to obtain the sulfide solid electrolyte of the present example.

Analysis confirmed that the molecular formula of the solid electrolyte is Li₆Sb_{0.0444}P_{0.9556}S_{4.9722}O_{0.0278}Cl.

### Example 9

A sulfide solid electrolyte of the present example was obtained by the following preparation method:
(1) Li₂S, Sb₂S₅, Li₂O, and a partial molar amount of P₂S₅ were mixed at a specific molar ratio, loaded into a ball mill jar, and sealed. A primary milling was performed, where a rotation speed of the primary milling is 430 r/min, and a time for the primary milling is 1 h. The ball mill jar was transferred into a glove box, then the remaining molar amounts of P₂S₅ and LiCl were added, and a secondary milling was performed, where a rotation speed of the secondary milling is 410 r/min and a time for the secondary milling is 5 h, to obtain an intermediate phase.
(2) A sintering treatment was performed on the intermediate phase, where a temperature of the sintering treatment is 520° C. and a time for the sintering treatment is 5 h, to obtain a sintered product. The sintered product was milled using a crusher to obtain the sulfide solid electrolyte of the present example.

Analysis confirmed that the molecular formula of the solid electrolyte is Li₆Sb_{0.0444}P_{0.9556}S_{4.9722}O_{0.0278}Cl.

### Comparative Example 1

A sulfide solid electrolyte of the comparative example was obtained by the following preparation method:
(1) Li₂S, P₂S₅, LiCl and Sb₂O₅ were mixed at a specific molar ratio, loaded into a ball mill jar, and sealed. A milling was performed, where a rotation speed of the milling is 410 r/min and a time for the milling is 4 h, to obtain an intermediate phase.
(2) A sintering treatment was performed on the intermediate phase, where a temperature of the sintering treatment is 560° C. and a time for the sintering treatment is 5 h, to obtain a sintered product. The sintered product was milled using a crusher to obtain a sulfide solid electrolyte of the present comparative example.

Analysis confirmed that the molecular formula of the solid electrolyte is Li₆Sb_{0.05}P_{0.95}S_{4.875}O_{0.125}Cl.

### Comparative Example 2

A sulfide solid electrolyte of the comparative example was obtained by the following preparation method:
(1) Li₂S, P₂S₅, P₂O₅, Sb₂S₅ and LiI were weighed at a specific molar ratio, and poured into a ball mill jar, with a rotation speed of 600 rpm, ball milled for 24 h to obtain an intermediate phase.
(2) The intermediate phase was sintered at 490° C. under vacuum for 4 h, to obtain the sulfide solid electrolyte of the present comparative example. Analysis confirmed that the molecular formula of the solid electrolyte is Li₆Sb_{0.8}P_{0.2}S_{4.5}O_{0.5}I.

### Comparative Example 3

A preparation method of a sulfide solid electrolyte of the present comparative example is basically the same as that of Example 4, except that Sb₂S₃ is used instead of Sb₂S₅ to obtain the sulfide solid electrolyte of the present comparative example. Analysis confirmed that the molecular formula of the solid electrolyte is Li₆Sb_{0.0667}P_{0.933}S_{4.9055}O_{0.0278}Cl.

### Comparative Example 4

A preparation method of a sulfide solid electrolyte of the present comparative example is basically the same as that of Example 1, except that Sb₂S₅, a P source, an O source, a Li source and a Cl source are mixed and milled, where a rotation speed of the milling is 410 r/min and a time for the milling is 5 h, to obtain a sulfide solid electrolyte of the present comparative example. Analysis confirmed that the molecular formula of the solid electrolyte is Li₆Sb_{0.0444}P_{0.9556}S_{1.9722}O_{0.0278}Cl.

### Comparative Example 5

A preparation method of a sulfide solid electrolyte of the present comparative example is basically the same as that of Example 3, except that Sb₂O₅ is used to replace 10 wt % of Sb₂O₅ in Example 3, to obtain a sulfide solid electrolyte of the present comparative example. Analysis confirmed that the molecular formula of the solid electrolyte is Li₆Sb_{0.0667}P_{0.9333}S_{4.9583}O_{0.0417}Cl.

### Comparative Example 6

A preparation method of a sulfide solid electrolyte of the present comparative example is basically the same as that of Example 3, except that the addition amounts of the Sb element and the O element are changed, to obtain the sulfide solid electrolyte of the present comparative example. Analysis confirmed that the molecular formula of the solid electrolyte is Li₆Sb_{0.02}P_{0.99}S_{4.99}O_{0.01}Cl.

### Test Example

1. XPS (X-ray Photoelectron Spectroscopy) and XRD (X-ray Diffraction) tests were performed on the above examples and comparative examples, and Raman detections were performed on Example 4 and Comparative Example 6.

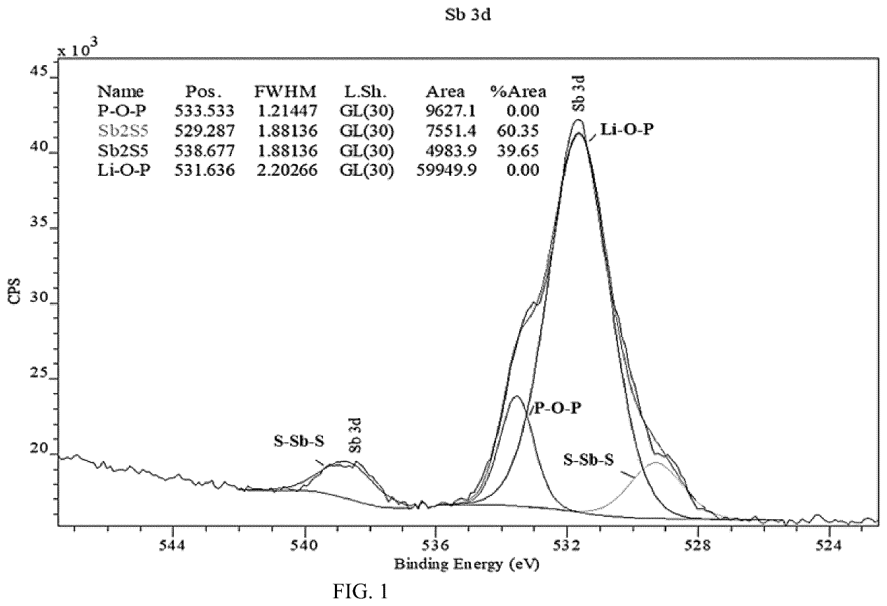

From the XPS spectrum, the percentage of Sb—S bonding in the total bonding formed by Sb can be obtained, with specific data listed in Table 1. FIG. 1 is a XPS spectrum of the sulfide solid electrolyte according to Example 4.

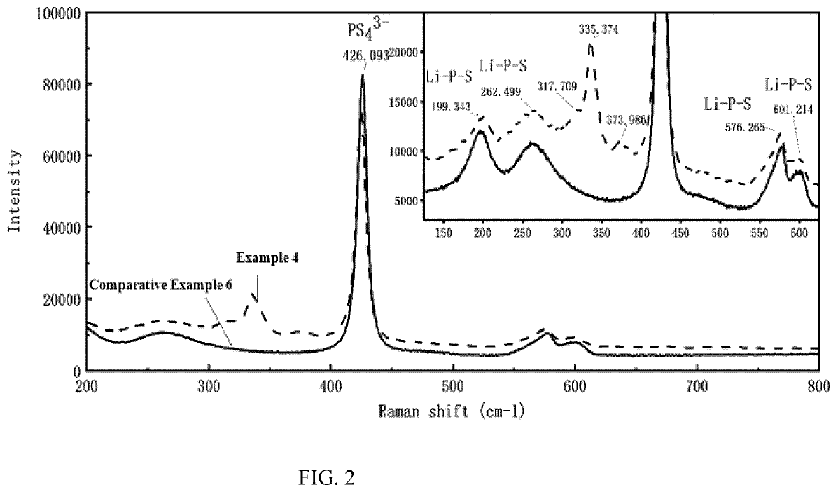

From the Raman spectrum, it can be seen that the Raman peak at 335.375 is attributed to a group containing both Sb and S elements, confirming the successful synthesis of the sulfide solid electrolyte, as shown in FIG. 2.

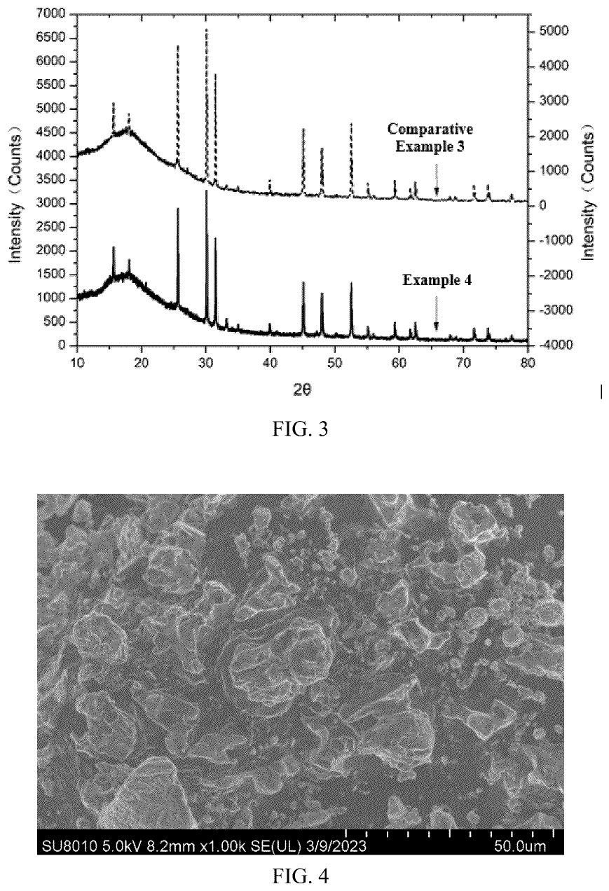

From the XRD pattern, the intensities Iₐ, I_{b}, I_{c} of the diffraction peaks at 2θ of 29.8±0.25°, 31.45±0.25° and 33.33±0.25° were obtained, with specific data listed in Table 1. FIG. 3 is a XRD pattern of the sulfide solid electrolytes according to Comparative Example 3 and Example 4.

TABLE 1

| | | | | | | Existence |
|---|---|---|---|---|---|---|
| | | | | | | percentage |
| | | | | | | of Sb—S |
| | | | | I_{c}/Iₐ | I_{c}/I_{b} | bonding |
| | Iₐ | I_{b} | I_{c} | % | % | % |
| Example 1 | 5001 | 3703 | 930 | 18.60 | 25.11 | 98.5 |
| Example 2 | 4924 | 3638 | 949 | 19.27 | 26.09 | 99.4 |
| Example 3 | 3993 | 3001 | 805 | 20.16 | 26.82 | 99 |
| Example 4 | 3893 | 2755 | 977 | 25.10 | 35.46 | 99.8 |
| Example 5 | 4228 | 3061 | 851 | 20.13 | 27.80 | 99.3 |
| Example 6 | 5583 | 4042 | 1011 | 18.11 | 25.01 | 98.0 |
| Example 7 | 4586 | 3228 | 886 | 19.32 | 27.45 | 98.6 |
| Example 8 | 4593 | 3202 | 897 | 19.53 | 28.01 | 98.6 |
| Example 9 | 4603 | 2986 | 875 | 19.01 | 29.30 | 99.0 |
| Comparative | 5230 | 3750 | 200 | 3.82 | 5.33 | 2 |
| Example 1 | | | | | | |
| Comparative | 5082 | 3807 | 605 | 11.90 | 15.89 | 97.8 |
| Example 2 | | | | | | |
| Comparative | 4506 | 3109 | 823 | 18.26 | 26.47 | 91 |
| Example 3 | | | | | | |
| Comparative | 5258 | 3801 | 890 | 16.93 | 23.41 | 98.3 |
| Example 4 | | | | | | |
| Comparative | 6210 | 4210 | 432 | 6.96 | 10.26 | 94 |
| Example 5 | | | | | | |
| Comparative | 5367 | 3945 | 627 | 11.68 | 15.89 | 98.1 |
| Example 6 | | | | | | |

As shown in Table 1, the percentage of Sb—S bonding in the total bonding formed by Sb in Examples 1-9 all exceeded 9800, with I_{c}/Iₐ being 18-26%, and I_{b} being 25-36%.
2. The sulfide solid electrolytes prepared in the foregoing examples and comparative examples were subjected to ionic conductivity and air stability tests.

### (1) Ionic Conductivity

0.23 g of the sulfide solid electrolyte material was weighed and poured into the battery chamber. After maintaining pressure at 3 T for 10 minutes, a thickness of an electrolyte layer was measured. Blocking electrodes were placed on both sides of the electrolyte layer to complete an assembly of an impedance testing mold. The assembled impedance mold was allowed to stand at 25° C. for 2 h, and an impedance test was performed, to obtain an ionic conductivity of the sulfide solid electrolyte before storing. Specific data are shown in Table 2.

The fixed dew point of a simple glove box with a volume of 110 L was lowered and maintained for 4 h to remove moisture originally present in the equipment. The above impedance mold after 2 h of standing was placed into the glove box. A gas replacement was performed using a fixed-speed fan inside the glove box, with the gas replacement time fixed to 0.5 h, achieving a glove box dew point of −50° C. The side door of the glove box was closed to perform a storage experiment at an ambient temperature of 25° C. After storing for 1 h, an impedance test was performed, to obtain an ionic conductivity of the sulfide solid electrolyte after storing. Specific data are shown in Table 2.

### (2) Air Stability

2-1: Air stability was characterized by an ionic conductivity retention rate before and after storing, and the ionic conductivity retention rate is calculated using Formula 2:

$$Ionic Conductivity Retention Rate = σ 1 / σ 2 \qquad Formula 2$$

in Formula 2:
σ1 is the ionic conductivity of the sulfide solid electrolyte before storing; and
σ2 is the ionic conductivity of the sulfide solid electrolyte after storing.
Test results are shown in Table 2.
2-2: H₂S gas test was performed on the sulfide solid electrolytes prepared in Example 4 and Comparative Example 1 according to the following method:

The fixed dew point of a simple glove box with a volume of 110 L was lowered and maintained for 4 h to remove moisture originally present in the equipment. The sulfide solid electrolyte and H₂S gas tester were placed into the glove box. A gas replacement was performed using a fixed-speed fan inside the glove box, with the gas replacement time fixed to 0.5 h, achieving a glove box dew point of −50° C. The side door of the glove box was closed, and 2 g of sample powder was spread evenly in a container with a diameter of 4.5 cm. The tester was turned on for a storage experiment, with a storing duration of 1 h, to obtain H₂S gas concentration. Test results are shown in FIG. 6.

As seen in FIG. 6, the sulfide solid electrolyte of Comparative Example 1 generated H₂S gas at around 1100 s, while the sulfide solid electrolyte of Example 4 generated H₂S gas at around 1800 s. This indicates that the sulfide solid electrolyte of the present application has better air stability.

TABLE 2

| | Ionic | Ionic | |
|---|---|---|---|
| | conductivity | conductivity | Ionic conductivity |
| | before storing | after storing | retention |
| | mS/cm | mS/cm | rate % |
| Example 1 | 8.42 | 6.12 | 72.68 |
| Example 2 | 7.81 | 5.71 | 73.11 |
| Example 3 | 8.14 | 6.17 | 75.80 |
| Example 4 | 8.2 | 6.58 | 80.24 |
| Example 5 | 8.50 | 6.89 | 81.11 |
| Example 6 | 7.20 | 5.28 | 73.31 |
| Example 7 | 7.60 | 5.85 | 77.00 |
| Example 8 | 7.90 | 5.85 | 74.14 |
| Example 9 | 8.01 | 6.03 | 75.30 |
| Comparative | 5.31 | 2.01 | 37.85 |
| Example 1 | | | |
| Comparative | 4.98 | 3.24 | 65.05 |
| Example 2 | | | |
| Comparative | 6.53 | 4.20 | 64.31 |
| Example 3 | | | |
| Comparative | 7.95 | 5.65 | 71.06 |
| Example 4 | | | |
| Comparative | 7.01 | 4.87 | 69.47 |
| Example 5 | | | |
| Comparative | 7.54 | 5.40 | 71.60 |
| Example 6 | | | |

From Examples 1-9 and Comparative Examples 1-6 in Table 2, it can be seen that the sulfide solid electrolytes of the present application achieve an ionic conductivity retention rate of up to 81.11%, and have excellent ionic conductivity. In contrast, Comparative Examples 1-6 have a maximum ionic conductivity retention rate of only 71.60%, and relatively low ionic conductivity.

Finally, it should be noted that the foregoing examples are merely intended to describe the technical solutions of the present application rather than limit the present application. Although the present application has been described in detail with reference to the foregoing examples, persons of ordinary skill in the art should understand that they may still make modifications to the technical solutions described in the foregoing examples or make equivalent substitutions to some or all technical features therein. However, these modifications or substitutions do not cause the essence of the corresponding technical solutions to depart from the scope of the technical solutions of the examples of the present application.

What is claimed is:

1. A sulfide solid electrolyte, having a chemical composition of Formula 1, wherein a percentage of Sb—S bonding in a total bonding formed by Sb is not less than 98%, 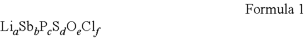
in Formula 1, 4.5≤a≤6.5, 0.02≤b≤0.9, 0.01≤e≤0.06, 0.9≤f≤1.6, b+c=1, d+e=5;
in an X-ray diffraction pattern of the sulfide solid electrolyte, intensities of diffraction peaks at 2θ of 29.8±0.25°, 33.33±0.25° and 31.45±0.25° are Iₐ, I_{b} and I_{c}, respectively, wherein I_{c}/Iₐ is 18-26%, and I_{c}/I_{b} is 25-36%.

2. The sulfide solid electrolyte according to claim 1, wherein a room-temperature ionic conductivity of the sulfide solid electrolyte is not less than 7.5 mS/cm.

3. The sulfide solid electrolyte according to claim 1, wherein an ionic conductivity retention rate of the sulfide solid electrolyte is not less than 70%.

4. The sulfide solid electrolyte according to claim 1, wherein the sulfide solid electrolyte is prepared by a method comprising the following processes:
mixing Sb₂S₅, a P source and an O source and performing a primary milling, adding a Li source and a Cl source and performing a secondary milling, to obtain an intermediate phase, sintering the intermediate phase, to obtain the sulfide solid electrolyte.

5. The sulfide solid electrolyte according to claim 2, wherein the sulfide solid electrolyte is prepared by a method comprising the following processes:
mixing Sb₂S₅, a P source and an O source and performing a primary milling, adding a Li source and a Cl source and performing a secondary milling, to obtain an intermediate phase, sintering the intermediate phase, to obtain the sulfide solid electrolyte.

6. The sulfide solid electrolyte according to claim 3, wherein the sulfide solid electrolyte is prepared by a method comprising the following processes:
mixing Sb₂S₅, a P source and an O source and performing a primary milling, adding a Li source and a Cl source and performing a secondary milling, to obtain an intermediate phase, sintering the intermediate phase, to obtain the sulfide solid electrolyte.

7. A preparation method of the sulfide solid electrolyte according to claim 1, comprising the following steps:
(1) mixing Sb₂S₅, a P source and an O source and performing a primary milling, then adding a Li source and a Cl source and performing a secondary milling, to obtain an intermediate phase; and
(2) performing a sintering treatment on the intermediate phase, to obtain the sulfide solid electrolyte.

8. The preparation method of the sulfide solid electrolyte according to claim 7, wherein a room-temperature ionic conductivity of the sulfide solid electrolyte is not less than 7.5 mS/cm.

9. The preparation method of the sulfide solid electrolyte according to claim 7, wherein an ionic conductivity retention rate of the sulfide solid electrolyte is not less than 70%.

10. The preparation method of the sulfide solid electrolyte according to claim 7, wherein in step (1), the P source comprises at least one of P₂O₅ and P₂S₅; the O source comprises at least one of P₂O₅ and Li₂O; the Li source comprises at least one of Li₂O, Li₂S and LiCl; the Cl source comprises LiCl.

11. The preparation method of the sulfide solid electrolyte according to claim 8, wherein in step (1), the P source comprises at least one of P₂O₅ and P₂S₅; the O source comprises at least one of P₂O₅ and Li₂O; the Li source comprises at least one of Li₂O, Li₂S and LiCl; the Cl source comprises LiCl.

12. The preparation method of the sulfide solid electrolyte according to claim 9, wherein in step (1), the P source comprises at least one of P₂O₅ and P₂S₅; the O source comprises at least one of P₂O₅ and Li₂O; the Li source comprises at least one of Li₂O, Li₂S and LiCl; the Cl source comprises LiCl.

13. The preparation method of the sulfide solid electrolyte according to claim 7, wherein in step (1), a rotation speed of the primary milling is 350-550 r/min, and a time for the primary milling is 0.5-2 h.

14. The preparation method of the sulfide solid electrolyte according to claim 8, wherein in step (1), a rotation speed of the primary milling is 350-550 r/min, and a time for the primary milling is 0.5-2 h.

15. The preparation method of the sulfide solid electrolyte according to claim 9, wherein in step (1), a rotation speed of the primary milling is 350-550 r/min, and a time for the primary milling is 0.5-2 h.

16. The preparation method of the sulfide solid electrolyte according to claim 7, wherein in step (1), a rotation speed of the secondary milling is 350-550 r/min, and a time for the secondary milling is 3-5 h.

17. The preparation method of the sulfide solid electrolyte according to claim 8, wherein in step (1), a rotation speed of the secondary milling is 350-550 r/min, and a time for the secondary milling is 3-5 h.

18. The preparation method of the sulfide solid electrolyte according to claim 9, wherein in step (1), a rotation speed of the secondary milling is 350-550 r/min, and a time for the secondary milling is 3-5 h.

19. The preparation method of the sulfide solid electrolyte according to claim 7, wherein a temperature of the sintering treatment is 530-580° C., and a time for the sintering treatment is 4-6 h.

20. An all-solid-state lithium-ion battery, comprising the sulfide solid electrolyte according to claim 1.
